(19) United States
(12) Patent Application Publication
(10) Pub. No.: US 2025/0284138 A1
(43) Pub. Date: Sep. 11, 2025

(54) VIRTUAL DISPLAY SYSTEMS FOR MULTIPLE VIEWERS INCLUDING A FRUSTRUM PRISM AND/OR ONE OR MORE MOVABLE REFLECTIVE SURFACES

(71) Applicant: GM GLOBAL TECHNOLOGY OPERATIONS LLC, Detroit, MI (US)

(72) Inventors: Tzvi Philipp, Bet Shemesh (IL); Thomas A. Seder, Fraser, MI (US); Manoj Kumar Sharma, Troy, MI (US); Joseph F. Szczerba, Grand Blanc, MI (US)

(21) Appl. No.: 18/600,878

(22) Filed: Mar. 11, 2024

(51) Int. Cl. G02B 30/33; G02B 5/04

(52) U.S. Cl. CPC G02B 30/33; G02B 5/04

(57) ABSTRACT

A virtual display system includes: a frustrum prism including reflective surfaces or refractive surfaces; and a projector configured to generate a light beam having a hologram sub-divided into multiple sub-holograms respectively for multiple viewers, and direct the light beam at the frustrum prism. The frustrum prism is configured to split the light beam into multiple sub-light beams via the reflective surfaces or the refractive surfaces, and direct the sub-holograms at eyes of the viewers.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to virtual image displays within a vehicle.

Display devices are used in a variety of applications. Some example display devices are flat panel displays, projection displays, and head-up displays. Display devices can be either of a transmission or reflection type. A vehicle may include multiple display devices to display various information to vehicle occupants (or observers). For example, some vehicles include an infotainment system that includes a display that displays various infotainment and other vehicle information.

### SUMMARY

A virtual display system is disclosed and includes: a frustrum prism including reflective surfaces or refractive surfaces; and a projector configured to generate a light beam having a hologram sub-divided into multiple sub-holograms respectively for multiple viewers, and direct the light beam at the frustrum prism. The frustrum prism is configured to split the light beam into multiple sub-light beams via the reflective surfaces or the refractive surfaces, and direct the sub-holograms at eyes of the viewers.

In other features, the frustrum prism includes the reflective surfaces. The reflective surfaces are configured to reflect the sub-holograms at the eyes of the viewers.

In other features, the frustrum prism includes the refractive surfaces. The refractive surfaces are transmissive and configured to refract the sub-holograms at the eyes of the viewers.

In other features, the virtual display system further includes a control module configured to control a spatial light modulator of the projector to encode each of the sub-holograms with a respective set of eye boxes for each of the viewers.

In other features, the frustrum prism is steerable.

In other features, the reflective surfaces or the refractive surfaces are movable to direct the sub-light beams at the viewers to display images to the viewers concurrently.

In other features, the frustrum prism includes four reflective surfaces that each reflect a respective one of the sub-holograms to a respective one of the viewers.

In other features, the light beam is transmitted through the frustrum prism and portions of the light beam including the sub-holograms are refracted respectively by the refractive surfaces and directed to the viewers.

In other features, the virtual display system further includes a control module, where the projector includes a spatial light modulator and the control module is configured control the spatial light modulator to at least one of: implement a lens function to independently establish a virtual image distance for each of the viewers; and encode a focal length for each of the viewers into a respective one of the sub-holograms for that viewer per frame.

In other features, a vehicle assembly includes: the virtual display system; and a vehicle support structure supporting the frustrum prism and the projector.

In other features, a virtual display system is disclosed and includes: plates including reflective surfaces; and a projector configured to generate a light beam having a hologram sub-divided into sub-holograms respectively for multiple viewers, and direct the light beam at the plates. The plates are configured to split the light beam into sub-light beams via the reflective surfaces and direct the sub-holograms at eyes of the viewers.

In other features, the virtual display system further includes: eye trackers configured to track locations and gaze directions of the eyes of the viewers; actuator assemblies configured to adjust locations and orientations of the plates; and a control module configured, based on the locations and the gaze directions of the eyes, to adjust the locations and orientations of the plates.

In other features, the control module is configured to independently control movement of each of the plates and control the projector to display images to the viewers concurrently.

In other features, the virtual display system further includes a control module configured to control a spatial light modulator of the projector to encode each of the sub-holograms with a respective set of eye boxes for each of the viewers.

In other features, the virtual display system further includes a control module, where the projector includes a spatial light modulator and the control module is configured control the spatial light modulator to at least one of: implement a lens function to independently establish a virtual image distance for each of the viewers; and encode a focal length for each of the viewers into a respective one of the sub-holograms for that viewer per frame.

In other features, a vehicle assembly is disclosed and further includes: the virtual display system; and a vehicle support structure supporting the plates and the projector.

In other features, a multiplexed virtual display system is disclosed and includes: a steerable plate including a reflective surface; a projector configured to generate a light beam having a frame rate of multiple times a refresh rate, and direct the light beam at the steerable plate such that images are displayed to each of multiple viewers at the refresh rate, where the steerable plate is configured to reflect the light beam via the reflective surface and direct the light beam at eyes of the viewers to display the images respectively to each of the viewers concurrently; a motor actuator assembly configured to move the steerable plate; eye trackers configured to detect locations and gaze angles of the eyes of the viewers; and a control module configured, based on the locations and gaze angles, to control the movement of the steerable plate to direct the light beam at the eyes of the viewers.

In other features, the control module is configured to control a spatial light modulator of the projector to encode each of sub-holograms with a respective set of eye boxes for each of the viewers.

In other features, the projector includes a spatial light modulator. The control module is configured control the spatial light modulator to at least one of: implement a lens function to independently establish a virtual image distance for each of the viewers; and encode a focal length for each of the viewers into a respective one of multiple holograms for that viewer per frame.

In other features, a vehicle assembly is disclosed and includes: the multiplexed virtual display system; and a vehicle support structure supporting the motor actuator assembly, the steerable plate, and the projector.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side view of an example virtual display system including a frustrum prism implemented in a vehicle in accordance with the present disclosure;

FIG. 2 is a functional block diagram of an example projector directing a light beam at a frustrum prism or multiple movable plates with reflective surfaces in accordance with the present disclosure;

FIG. 3 is an overhead example representative view of a beam of light from a spatial light modulator (SLM) including sub-holograms with respective sets of eye boxes impinging upon angled surfaces of a frustrum prism to generate sub-light beams in accordance with the present disclosure;

FIG. 4 is a perspective view of a frustrum prism and corresponding projector, where angled surfaces of the frustrum prism are implemented as reflective surfaces in accordance with the present disclosure;

FIG. 5 is a perspective view of a frustrum prism and corresponding projector, where angled surfaces of the frustrum prism are implemented as refractive surfaces in accordance with the present disclosure;

FIG. 6 is a functional block diagram and perspective view of a feedback system including movable plates having reflective surfaces in accordance with the present disclosure; and

FIG. 7 illustrates an example virtual display method for displaying multiple virtual images for multiple viewers in accordance with the present disclosure.

In the drawings, reference numbers may be reused to identify similar and/or identical elements.

### DETAILED DESCRIPTION

In a shared vehicle where occupants are sitting in a “campfire” like arrangement facing each other, a user experience where each occupant is able to interact with one of multiple virtual displays may be provided. The virtual displays may appear by the occupants to project images that float in front of each occupant, for example, 1 meter away from each occupant. The occupants may interact with the displayed images by making gestures and/or providing voice commands. The imaging systems implement gesture recognition and voice recognition for received gestures and/or voice commands. The interaction may also be based on gaze directions (or angles) of the occupants, which may be determined using tracking cameras that track the gaze angles of the eyes of the occupants. When an occupant looks at a certain object in a virtual image, the system may provide certain information and/or respond based on the corresponding gaze angle of the occupant. Each virtual display of a vehicle can be expensive and relatively large.

The examples set forth herein include non-multiplexed and multiplexed virtual display systems for vehicle occupants (or observers). The non-multiplexed virtual display systems may include a single projector and either a frustrum prism or multiple movable plates having reflective surfaces, which may be positioned and oriented to serve similar functions as facets (or angled surfaces) of a frustrum prism. The multiplexed virtual display systems may include a single projector and a single steerable mirror. The same or different content may be displayed by the single projectors to each of multiple viewers. The virtual display systems are configured in a “campfire” configuration, where the viewers are facing each other, as opposed to all viewers sitting and facing a same direction. Each of the single projectors includes a SLM the generates sub-divided encoded holograms. As an example, each hologram generated by a projector may be sub-divided to provide multiple sub-holograms, which are directed via a frustrum prism or one or more movable reflective surfaces to the respective viewers. In the embodiments including a frustrum prism (or pyramid-shaped prism) or multiple movable reflective surfaces, the frustrum prism or the movable reflective surfaces split a SLM output light beam into separate sub-light beams. In an embodiment including a single steerable mirror, the SLM output light beam is directed at the steerable mirror, which sequentially and iteratively rotated to direct the light beam at the viewers.

The systems disclosed herein allow each vehicle occupant to have an individualized viewing perspective that cannot be observed by other occupants in the vehicle. The systems also allow all or some of the occupants to share the same content. The individualized and shared viewing perspectives may be implemented for gaming applications, movie viewing applications, information providing applications, etc.

The disclosed systems minimize the number of image projectors (or display sources) and include display components associated with displaying images for multiple vehicle occupants. This reduces associated costs, number of components, and spatial (or volume) requirements (or the amount of space dedicated within a vehicle for display systems and components). The examples include use of a single projector to project images with the same or different content concurrently to multiple occupants. Images for the occupants are provided concurrently and may be viewed on independent virtual displays. The images originate from the same projector.

The examples disclosed herein may include a virtual three-dimensional (3D) display that projects real time “holograms” encoded via a computer and/or control module controlled spatial light modulator (SLM). A lens function is encoded and/or programmed into holograms of two images being concurrently displayed. The focus lens function independently establishes the virtual image distances (VIDs) respectively appropriate for the occupants. The focus lens function is a dynamic function that changes in time per frame and has the functionality of a lens. In other words, the encoded focal length for each occupant (or viewer) is encoded into the hologram (or respective sub-hologram) for each viewer per frame. There is one lens function for each viewer. The VIDs and other information as described herein may be encoded into the holograms. Such a projection system enables the encoded projected information to be replicated per viewer to expand the viewing region or number of eye boxes visible for each viewer. This is achieved by filling a potential viewing region of an observer with multiple renderings of an image to be viewed by the observer independent of the viewing perspective or angle. The encoding can be further expanded to allow a subdivision of the encoding SLM, provided the SLM is large enough to maintain a target resolution to support multiple observers viewing different information.

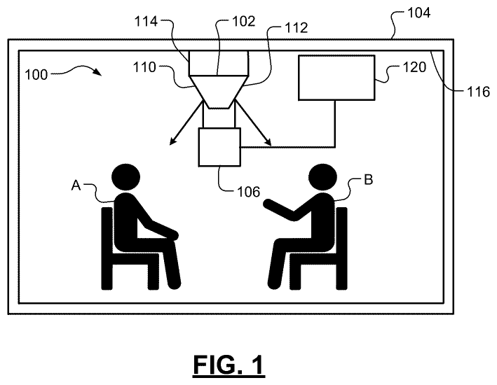

FIG. 1 shows a virtual display system 100 including a frustrum prism 102 implemented in a vehicle 104. A projector 106 generates a light beam having content for multiple viewers (two viewers A and B are shown). Although two viewers are shown, the projector 106 and frustrum prism 102 may generate additional images for additional viewers. The light beam is directed at the frustrum and is split into multiple sub-light beams that are reflected off facets (or angled surfaces) 110, 112 of the frustrum prism 102 and directed at the viewers A, B. The frustrum prism 102 may be mounted via a mounting bracket assembly 114 to a roof 116 of the vehicle 104. In an embodiment, the frustrum prism 102 and the projector 106 are implemented in a ceiling of the vehicle 104. The projector 106 is controlled by a control module 120.

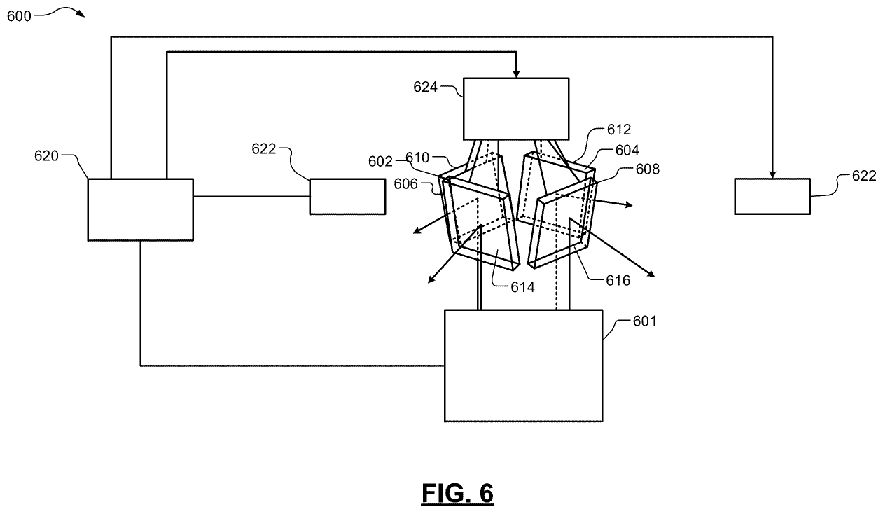

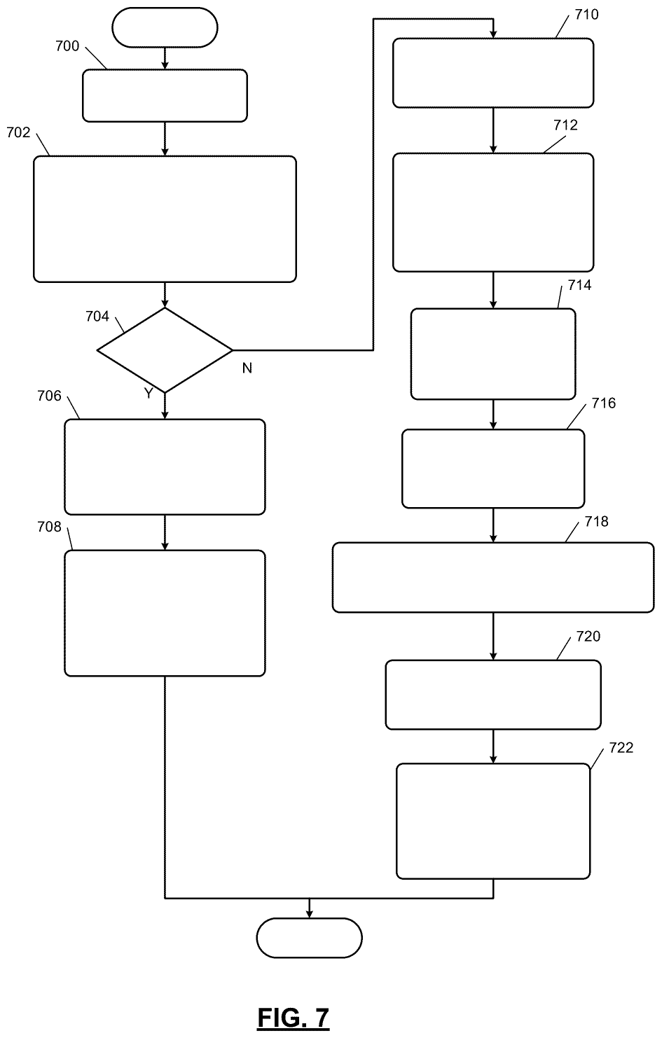

Although cameras are not shown in FIG. 1, cameras may be included and used by the control module 120 to determine what information to provide to each of the users based on gestures and/or gaze angles of the viewers. Example cameras are shown in FIG. 6. The cameras may also be used to detect presence of viewers. The projector 106 may generate images for each viewer when that viewer is present.

In an embodiment, the mounting bracket assembly 114 may include a motor actuator assembly to rotate the frustrum prism 110. Each facet of the frustrum prism 110 is steerable to each viewer. The control module 120 may control the motor actuator assembly as described below to provide a best image to each viewer. This may include moving the facets to reflect light beams in the directions of the lines of sight of the viewers.

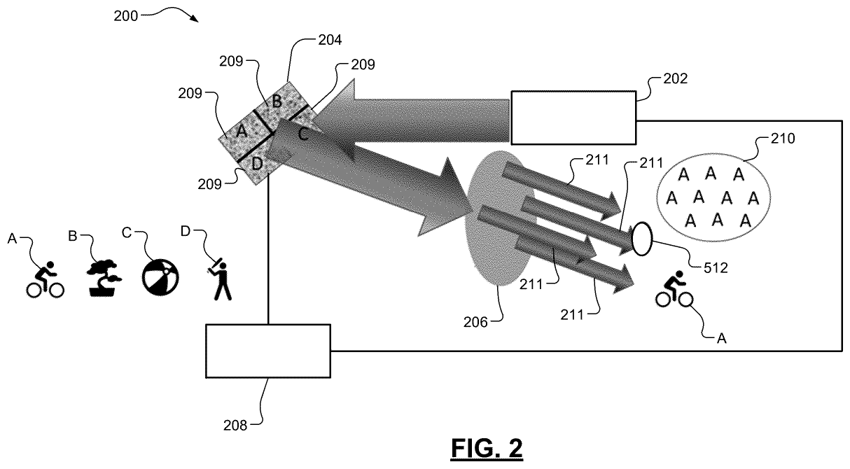

FIG. 2 shows a projector 200 that includes a light source 202 (e.g., a laser) and a spatial light modulator (SLM) 204 that directs a light beam at a frustrum prism or multiple movable plates with reflective surfaces, represented as an oval 206. Examples of a frustrum prism and movable plates with reflective surfaces are shown in FIGS. 1 and 3-6. A control module 208 (e.g., one of the control modules 120, 620 of FIGS. 1 and 6) controls states of the SLM 204 and the movable plates if included. The frustrum prism and movable plates split a beam from the SLM 204 into multiple beams (e.g., 4 beams) having respective views, which may include the same or different content. The SLM 204 is controlled by the control module 208 to generate the hologram, which is encoded with multiple images (e.g., 4 images) using separate image lens functions for independent virtual image locations. The projector 200 outputs the hologram divided into the multiple sub-holograms (e.g., 4 holograms) 209 that are encoded for separate images (e.g., images A-D), separate virtual image distances, separate propagation paths, and directed to i) different faces (or angled surfaces) of a frustrum prism, or ii) reflective surfaces of movable plates. Depending on the embodiment, the frustrum prism or the movable plates split the beam from the SLM 204 into multiple sub-light beams (or channels) 211. Each channel may have a respective computer processed image.

FIG. 2 is a simplified view of the projector 200. Each hologram and frame of the SLM 204 is split into sub-holograms and sub-frames, which are respectively directed to the viewers. Each of the sub-holograms, designated 209, includes multiple replicated eye boxes for each viewer to account for movement of the viewers. Each of the viewers is able to see one of the eye boxes in the set of replicated eye boxes provided for that viewer. In FIG. 2, a representative eye box region 210 is shown including replicated eye boxes, which are represented as replicated versions of image A of a biker displayed multiple times per frame and at different angles to accommodate movement and/or different gaze angles of the corresponding viewer. Although each of the sub-holograms 209 are shown having a single image, A, B, C, or D, each of the sub-holograms has information for multiple versions of the corresponding image, as shown by eye box region 210. Each viewer sees only one of the eye box images at any moment in time. Oval 512 represents a viewer's eye of the viewer seeing image A. Other viewers may see images B, C, and D.

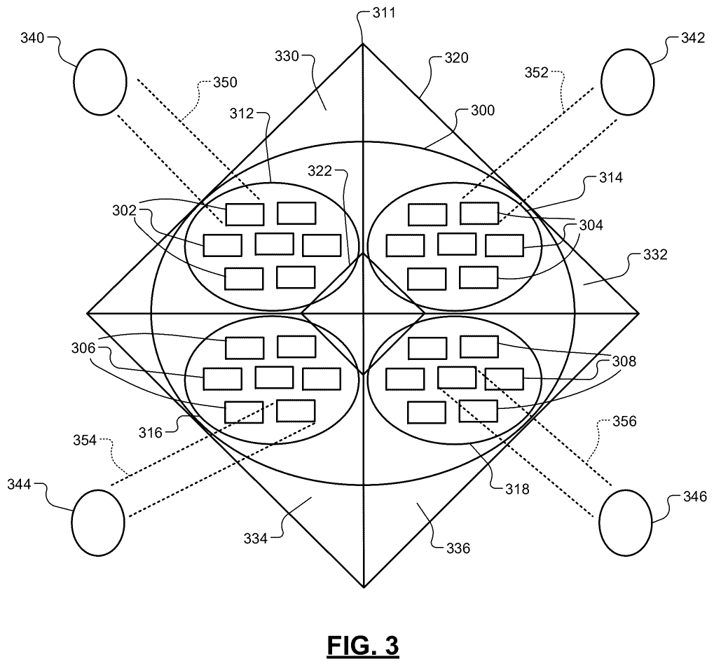

FIG. 3 shows an overhead example representative view of a beam of light 300 from a SLM (e.g., the SLM 204 of FIG. 2) including respective sub-holograms with respective sets of eye boxes 302, 304, 306, 308 impinging upon facets (or angled surfaces) of a frustrum prism 311 to generate sub-light beams 312, 314, 316, 318 in respective subregions of the output beam 300 of the corresponding projector. The frustrum prism 311 includes a first planar surface 320 and a second planar surface 322 that extends parallel to the first planar surface. The frustrum prism 311 further includes four angled planar surfaces 330, 332, 334, 336. Each of four viewers, which are represented by ovals 340, 342, 344, 346, see the image in one of the corresponding sets of eye boxes. This is represented by light beam portions 350, 352, 354, 356. The arrangement of the eye box replication may be modified provided the beam diameter is large and there is sufficient resolution to contain simultaneously multiple sets of eye boxes for the multiple viewers in four subregions of the output beam of the projector.

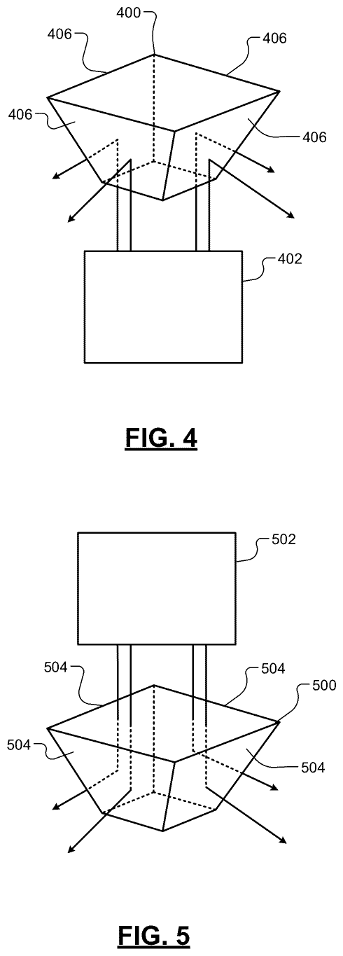

FIG. 4 shows a frustrum prism 400 and corresponding projector 402, where facets (or angled surfaces) 406 of the frustrum prism 400 are implemented as reflective surfaces. The angled surfaces 406 reflect portions of a light beam projected by the projector 402 to respective viewers (e.g., viewers 1-4). The projector 402 may be similar to one of the projectors (e.g., 106 or 200) of FIGS. 1-2. In an embodiment, the frustrum prism 400 and the projector 402 are implemented in a ceiling of a vehicle and supported by one or more structural members of the roof of the vehicle.

FIG. 5 shows a frustrum prism 500 and corresponding projector 502, where facets (or angled surfaces) 504 of the frustrum prism 500 are implemented as refractive surfaces. Portions of a light beam output from the projector 502 are refracted off the angled surfaces 504 and directed to respective viewers (e.g., viewers 1-4). In an embodiment, the frustrum prism 500 and the projector 502 are implemented in a ceiling of a vehicle and supported by one or more structural members of the roof of the vehicle.

The implementation of FIG. 5 may experience distortion and chromatic dispersion. This may be addressed at the generation of the hologram via the corresponding control module and SLM and/or may be addressed by adding an additional optical element, such as a programmable liquid crystal phase plate between the projector 502 and the frustrum prism 500. The chromatic dispersion may also or alternatively be addressed i) via the selection of the glass material of the frustrum, and/or ii) by addition of optics positioned along the optical path and configured to compensate for the chromatic dispersion.

FIG. 6 shows a feedback system 600 including movable plates 602, 604, 606, 608 having reflective surfaces 610, 612, 614, 616. Portions of a light beam output from a projector 601 are reflected off the reflective surfaces 610, 612, 614, 616 and directed to respective viewers (e.g., viewers 1-4). The reflective surfaces 610, 612, 614, 616 may include metallic materials and/or coatings. Although the reflective surfaces are shown as being front surfaces of the plates 602, 604, 606, 608, the reflective surfaces may be back surfaces of the plates 602, 604, 606, 608, where the portions of the light pass through glass bodies of the plates 602, 604, 606, 608 and are reflected off reflective back surfaces. In this manner, the plates 602, 604, 606, 608 are implemented as mirrors. In an embodiment, the projector 601, the plates 602, 604, 606, 608, and the motor actuator assemblies 624 are implemented in a ceiling of a vehicle and supported by one or more structural members of the roof of the vehicle.

The feedback system 600 may include control module 620, cameras 622, and motor actuator assemblies 624. The cameras 622 may be used to detect presence, locations, gaze directions and angles of the viewers. The control module 620 adjusts the locations and orientations of the plates 602, 604, 606, 608 and thus the reflective surfaces 610, 612, 614, 616 via the motor actuator assemblies 624 based on the outputs of the cameras 622. The motor actuator assemblies 624 may include motors, actuators, brackets, etc. for moving the plates 602, 604, 606, 608. The control module 620 may determine information to provide to each of the users based on gestures and/or gaze angles of the viewers detected via the cameras 622.

In an embodiment, instead of a single beam being directed from a SLM to and split by the plates 602, 604, 606, 608 into multiple sub-light beams, the SLM outputs a single beam that has multiple times (e.g., four times for four viewers) a refresh rate (e.g., 30 frames/second) of the virtual display. The single beam is directed at a single steerable mirror, which is rotated to direct the beam at each of the viewers. Thus, one mirror is used instead of four and rotated to direct images at the four viewers. The single mirror may be centrally located between the four viewers. Four images may be provided to four viewers via the single steerable mirror. Thus, instead of having four movable mirrors, a single steerable mirror may be implemented for the four viewers or a different number of viewers. The control module 620 may adjust the frame rate of the light beam directed at the steerable mirror based on the number of viewers. The steerable mirror may be of the point-to-point design rather than of the continuous sweep scanning mirror design.

FIG. 7 shows an example virtual display method for displaying multiple virtual images for multiple viewers. The operations may be iteratively performed. The operations may be performed by one of the control modules, one of the projectors, one of the SLMs, and if applicable one or more of the cameras referred to herein.

At 700, the control module controls the light source (e.g., laser) of the projector to generate a light beam. At 702, the control module controls the SLM to generate a hologram that is sub-divided into multiple sub-holograms for respective viewers. The sub-holograms include respective sets of replicated eye boxes for the viewers, as described above. A beam including the hologram is generated including multiple channels worth of information for the viewers.

At 704, the control module may determine whether a frustrum prism is being used to slip the beam with the hologram. If yes, operation 706 may be performed, otherwise operation 710 may be performed when multiple movable reflective surfaces are being used to split the beam with the hologram.

At 706, the beam with the hologram is directed at the angled surfaces of the frustrum prism. At 708, the beam is split into multiple sub-light beams for the respective channels and reflected or refracted by the angled surfaces of the frustrum prism to the viewers. The method may end subsequent to operation 708 or return to operation 702.

At 710, the beam with the hologram is directed at the reflective surfaces of the movable plates. At 712, the beam is split into multiple sub-light beams for the respective channels and reflected by the angled surfaces of the reflective surfaces of the movable plates to the viewers.

At 714, eye trackers (e.g., the cameras 622 of FIG. 6) may detect current locations and eye gaze directions (or angles) of eyes of the viewers. At 716, the control module may determine the locations and orientation of the reflective surfaces. This may include determining the X, Y, and Z locations of the reflective surfaces and associated x and y angles of the reflective surfaces.

At 718, the control module may calculate expected image locations of the sub-light beams generated for multiple viewers that are in different locations. At 720, the control module may calculate differences between current values of the eye trackers associated with the locations and eye gaze directions of the eyes of the viewers and the expected values of the image locations of the sub-light beams.

At 722, the control module may adjust one or more angles and/or locations of the one or more reflective surfaces to minimize errors and provide best views of images to the occupants. This is based on the locations and eye gaze directions of the viewers and the differences determined at 720. This may include positioning the reflective surfaces such that the generated sub-light beams are in the lines of sight of the viewers and are directed at and/or are parallel to the lines of sight (or viewing directions) of the viewers. The method may end after operation 722 or may return to operation 702.

The examples set forth herein minimize the number of projectors and corresponding components needed within a vehicle, which minimizes systems costs and associated space requirements. The examples allow multiple users to share the same projector and view the same or different images having the same or different content. The generated images are provided via the same or different virtual image distances and different propagation paths.

The above-described examples include a projector that subdivides the projected eye box replicator pupils into four sub zones or regions. Each region is provided with unique content for each one of the four viewers. In some embodiments, the output of the projector is directed to a frustrum shaped beam reflector (or frustrum prism with reflective surfaces) that directs portions of the beam towards the multiple viewers. In another embodiment, the output of the projector is directed to a frustrum shaped refractor (or frustrum prism with multiple refractive surfaces) that redirects portions of the beam towards multiple viewers. In another embodiment, the output of the projector is directed to the viewers via a steerable mirror and/or multiple movable plates (or mirrors). The projector and SLM of the steerable mirror implementation are operated at multiple times the refresh rate of the virtual display.

In another embodiment, the output of the projector is directed toward each viewer independently, where each facet of a steerable frustrum like beam splitter is independently controlled based upon outputs of eye tracking devices (e.g., cameras) to direct reflected beams to respective viewers. The “steerable frustrum like beam splitter” refers to the example implementation of FIG. 6 and includes multiple independently controlled plates. Each facet of the steerable frustrum like beam splitter has a bi-directional tilt allowing for a tilt in the x and y direction to compensate for the gaze direction of each viewer.

In some embodiments, the output of a projector is subdivided spatially into multiple images having unique VIDs and propagation paths where each image is subsequently directed to a different viewer simultaneously and/or concurrently via hologram lens encoding. The output (or hologram) of the projector is directed into a frustrum prism, which redirects the hologram to the users' eyes.

A virtual image projection display is disclosed that is configured to project simultaneously to four viewers by time sequential operation wherein hologram lens encoding creates a unique VID and propagation path for each viewer. Output of the virtual image projection display is redirected using a frustrum prism to the users' eyes.

The disclosed frustrum prism implementation disclosed have multiple different configurations including reflective and refractive implementations. A multiple plate design having angled reflective surfaces may be independently controlled via motor actuator assemblies that are able to tilt the plates such that the possible gaze angles of the viewers are covered by the field of view of the projector and generated replicated eye boxes.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A virtual display system comprising:
a frustrum prism comprising a plurality of reflective surfaces or a plurality of refractive surfaces; and
a projector configured to generate a light beam having a hologram sub-divided into a plurality of sub-holograms respectively for a plurality of viewers, and direct the light beam at the frustrum prism,
wherein the frustrum prism is configured to split the light beam into a plurality of sub-light beams via the plurality of reflective surfaces or the plurality of refractive surfaces, and direct the plurality of sub-holograms at eyes of the plurality of viewers.

2. The virtual display system of claim 1, wherein:
the frustrum prism comprises the plurality of reflective surfaces; and
the plurality of reflective surfaces are configured to reflect the plurality of sub-holograms at the eyes of the plurality of viewers.

3. The virtual display system of claim 1, wherein:
the frustrum prism comprises the plurality of refractive surfaces; and
the plurality of refractive surfaces are transmissive and configured to refract the plurality of sub-holograms at the eyes of the plurality of viewers.

4. The virtual display system of claim 1, further comprising a control module configured to control a spatial light modulator of the projector to encode each of the plurality of sub-holograms with a respective set of eye boxes for each of the plurality of viewers.

5. The virtual display system of claim 1, wherein the frustrum prism is steerable.

6. The virtual display system of claim 1, wherein the plurality of reflective surfaces or the plurality of refractive surfaces are movable to direct the plurality of sub-light beams at the plurality of viewers to display a plurality of images to the plurality of viewers concurrently.

7. The virtual display system of claim 1, wherein the frustrum prism comprises four reflective surfaces that each reflect a respective one of the plurality of sub-holograms to a respective one of the plurality of viewers.

8. The virtual display system of claim 1, wherein the light beam is transmitted through the frustrum prism and portions of the light beam comprising the plurality of sub-holograms are refracted respectively by the plurality of refractive surfaces and directed to the plurality of viewers.

9. The virtual display system of claim 1, further comprising a control module, wherein the projector comprises a spatial light modulator and the control module is configured control the spatial light modulator to at least one of:
implement a lens function to independently establish a virtual image distance for each of the plurality of viewers; and
encode a focal length for each of the plurality of viewers into a respective one of the plurality of sub-holograms for that viewer per frame.

10. A vehicle assembly comprising:
the virtual display system of claim 1; and
a vehicle support structure supporting the frustrum prism and the projector.

11. A virtual display system comprising:
a plurality of plates comprising a plurality of reflective surfaces; and
a projector configured to generate a light beam having a hologram sub-divided into a plurality of sub-holograms respectively for a plurality of viewers, and direct the light beam at the plurality of plates,
wherein the plurality of plates are configured to split the light beam into a plurality of sub-light beams via the plurality of reflective surfaces and direct the plurality of sub-holograms at eyes of the plurality of viewers.

12. The virtual display system of claim 11, further comprising:
a plurality of eye trackers configured to track locations and gaze directions of the eyes of the plurality of viewers;
a plurality of actuator assemblies configured to adjust locations and orientations of the plurality of plates; and
a control module configured, based on the locations and the gaze directions of the eyes, to adjust the locations and orientations of the plurality of plates.

13. The virtual display system of claim 12, wherein the control module is configured to independently control movement of each of the plurality of plates and control the projector to display a plurality of images to the plurality of viewers concurrently.

14. The virtual display system of claim 11, further comprising a control module configured to control a spatial light modulator of the projector to encode each of the plurality of sub-holograms with a respective set of eye boxes for each of the plurality of viewers.

15. The virtual display system of claim 11, further comprising a control module, wherein the projector comprises a spatial light modulator and the control module is configured control the spatial light modulator to at least one of:
implement a lens function to independently establish a virtual image distance for each of the plurality of viewers; and
encode a focal length for each of the plurality of viewers into a respective one of the plurality of sub-holograms for that viewer per frame.

16. A vehicle assembly comprising:
the virtual display system of claim 11; and
a vehicle support structure supporting the plurality of plates and the projector.

17. A multiplexed virtual display system comprising:
a steerable plate comprising a reflective surface;
a projector configured to generate a light beam having a frame rate of multiple times a refresh rate, and direct the light beam at the steerable plate such that images are displayed to each of a plurality of viewers at the refresh rate,
wherein the steerable plate is configured to reflect the light beam via the reflective surface and direct the light beam at eyes of the plurality of viewers to display the images respectively to each of the plurality of viewers concurrently;
a motor actuator assembly configured to move the steerable plate;
a plurality of eye trackers configured to detect locations and gaze angles of the eyes of the plurality of viewers; and
a control module configured, based on the locations and gaze angles, to control the movement of the steerable plate to direct the light beam at the eyes of the plurality of viewers.

18. The multiplexed virtual display system of claim 17, wherein the control module is configured to control a spatial light modulator of the projector to encode each of a plurality of sub-holograms with a respective set of eye boxes for each of the plurality of viewers.

19. The multiplexed virtual display system of claim 17, wherein:
the projector comprises a spatial light modulator; and
the control module is configured control the spatial light modulator to at least one of
implement a lens function to independently establish a virtual image distance for each of the plurality of viewers; and
encode a focal length for each of the plurality of viewers into a respective one of a plurality of holograms for that viewer per frame.

20. A vehicle assembly comprising:
the multiplexed virtual display system of claim 17; and
a vehicle support structure supporting the motor actuator assembly, the steerable plate, and the projector.
